(19) United States
(12) Patent Application Publication
(10) Pub. No.: US 2006/0153653 A1
(43) Pub. Date: Jul. 13, 2006

(54) Structural steel beam assemblies for a machining device

(76) Inventors: Chen-Sheng Lu, Taichung (TW); Shih-Fu Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,144

(22) Filed: Jan. 12, 2005

(51) Int. Cl. B23C 1/027

(52) U.S. Cl. 409/235

(57) ABSTRACT

A structural steel beam assembly for a machining device has multiple structural steel beams. The structural steel beams are connected together to form a hollow structure and a component such as a base, a saddle, a column or a neck of the machining device. The machining device made of structural steel beam assemblies is light and compact.

### BACKGROUND OF THE INVENTION

1. Field of the Invention

The present invention relates to assemblies for a machining device, and more particularly to structural steel beam assemblies for a machining device to make the machining device light and compact.

2. Description of Related Art

Machining devices such as machining centers and lathes are used to precisely cut smooth surfaces in steel or iron workpieces, and conventional machining devices are made of machined cast or cast iron.

With reference to FIG. 6, a conventional machining center comprises a base (80), a saddle (81), a table (82) a column (83), a neck (84), a head (85), a spindle (86) and a blade.

The base (80) has a top. The saddle (81) is mounted slidably on the top of the base (80), slides longitudinally relative to the base (80) and has a top. The table (82) is mounted slidably on the top of the saddle (81) and slides transversely relative to the base (80). The column (83) is mounted on the top the base (80) and has a front surface. The neck (84) is mounted slidably on the front surface of the column (83), slides vertically relative to the table (82) and has a front end. The head (85) is mounted on the front end of the neck (84). The spindle (86) extends through the head (85) and has a bottom end. The blade is mounted rotatably on the bottom end of the spindle (86).

With reference to FIG. 7, another conventional machining center comprises a base (90), a table (91), a column (92), a Y-axis saddle (93), a Z-axis saddle (94), a head (95), a spindle (96) and a blade.

The base (90) has a top.

The table (91) is mounted on the top of the base (90).

The column (92) is mounted on the top of the base (90) and has a top, a front surface and an overhang. The overhang projects from the front surface of the column (92) at the top.

The Y-axis saddle (93) is mounted slidably between the top of the base (90) and the overhang on the column (92), slides transversely relative to the base (90) and has a front.

The Z-axis saddle (94) is mounted slidably through the front of the Y-axis saddle (93) and slides vertically relative to the table (91).

The head (95) is mounted slidably through the Z-axis saddle (94), slide longitudinally relative to the base (90) and has a front end. The spindle (96) is mounted on front end of the head (95).

However, components of conventional machining centers are made separately of cast or cast iron, machined by using wooden templates and assembled to form the machining centers. Using iron and wooden templates to manufacture machining devices has the following defects.

1. The wooden templates restrict the shape of the cast iron so a machining device designer has to take the restriction of the wooden templates on the iron into account when the designer designs a machining device.

2. Each component of the machining device made of iron must be processed sequentially through casting or forging, tempering, machining and heat treatment. Therefore, manufacturing conventional machining devices is time-consuming.

3. The iron is weaker than steel in deformation resistance. Iron has a deformation resistance value about 62% of steel. Therefore, a machining device made of iron with the same strength as a steel machining device has a volume and weight much larger than the machining device made of steel.

To overcome the shortcomings, the present invention provides steel beam assemblies for a machining device to mitigate or obviate the aforementioned problems.

### SUMMARY OF THE INVENTION

The main objective of the invention is to provide structural steel beam assemblies for a machining device to make the machining device light and compact.

A structural steel beam assembly for a machining device in accordance with the present invention comprises multiple structural steel beams. The structural steel beams are connected together to form a hollow structure to form a component such as a base, a saddle or a column of the machining device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a machining center with multiple structural steel beam assemblies in accordance with the present invention;

FIG. 2 is an exploded perspective view of the machining center in FIG. 1;

FIG. 3 is a perspective view of the base of the machining center in FIG. 1;

FIG. 4 is an exploded perspective view of the base in FIG. 3;

FIG. 5 is a perspective view of another embodiment of a machining center with multiple structural steel beam assemblies in accordance with the present invention;

FIG. 6 is a perspective view of a conventional machining center in accordance with the prior art; and

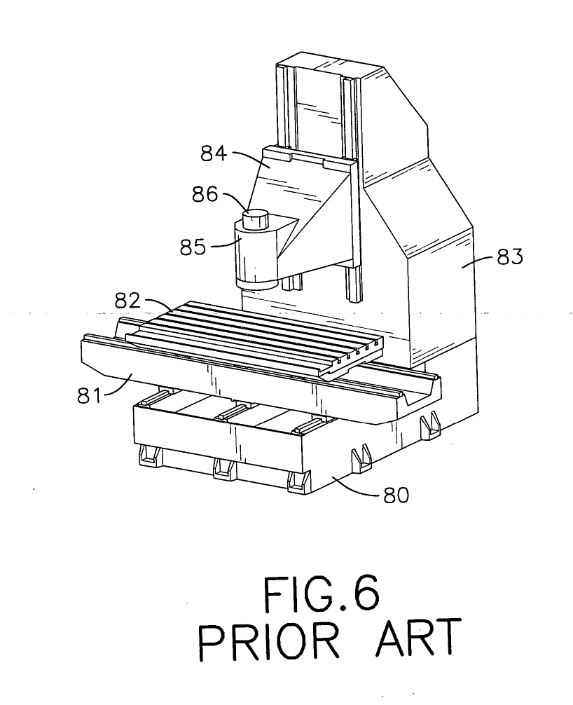

FIG. 7 is a perspective view of another embodiment of a conventional machining center in accordance with the prior art.

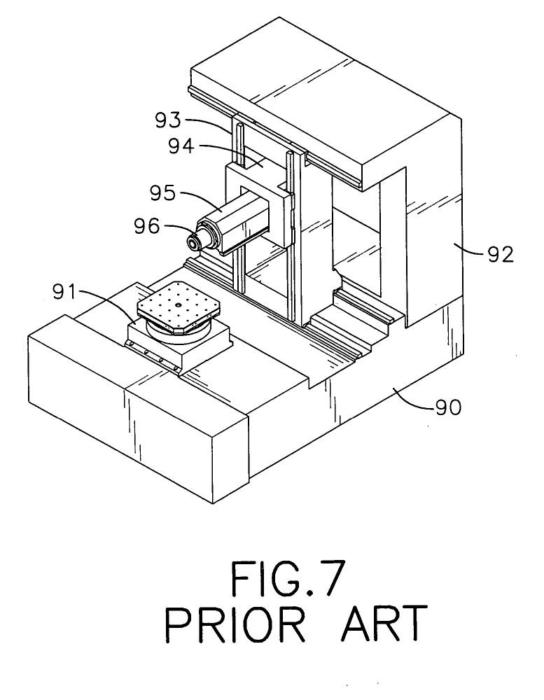

### DETAILED DESCRIPTION OF PREFERRED EMBODIMENT

A structural steel beam assembly for a machining device in accordance with the present invention comprises multiple structural steel beams. The structural steel beams are connected together to form a hollow structure and a component such as a base, a saddle, a column or a neck of the machining device.

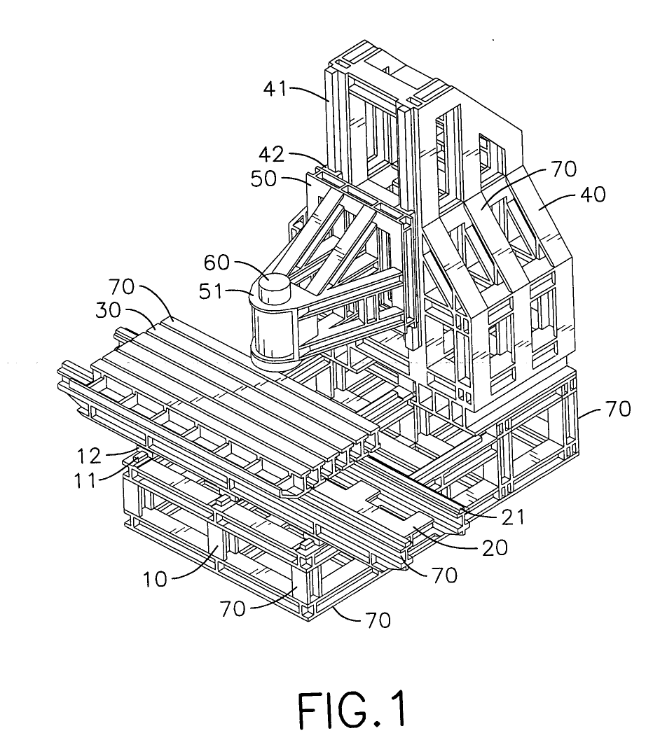

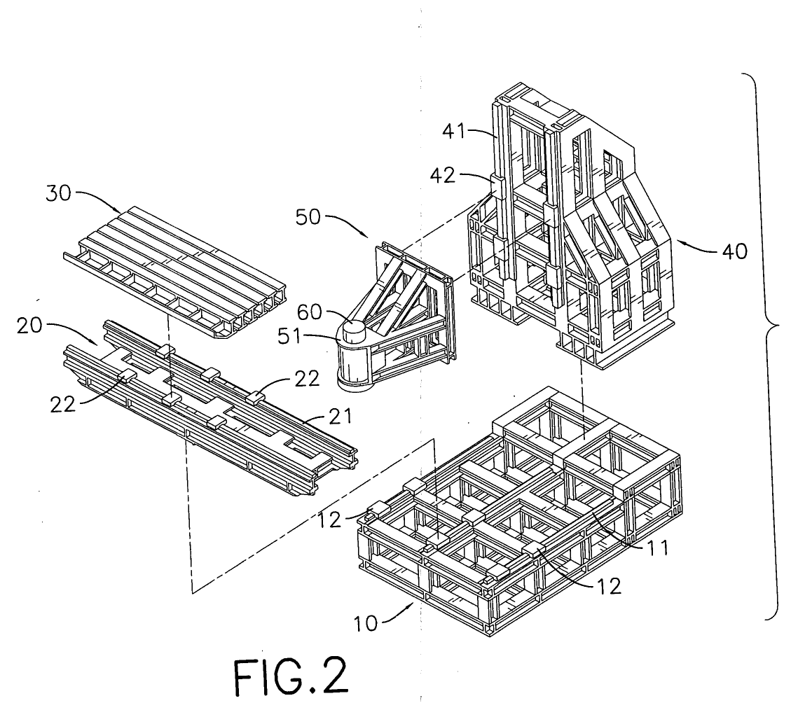

With reference to FIGS. 1 and 2, a first embodiment of the structural steel beam assemblies for a machining device in accordance with the present invention has a first, a second, a third, a fourth and a fifth structural assembly. The structural steel beam assemblies are assembled to form a machining center. The machining center comprises a base (10), a saddle (20), a table (30), a column (40), a neck (50), a head (51) and a spindle (60), which may be made individually of structural steel beams (70) such as channel iron, H-beams and I-beams.

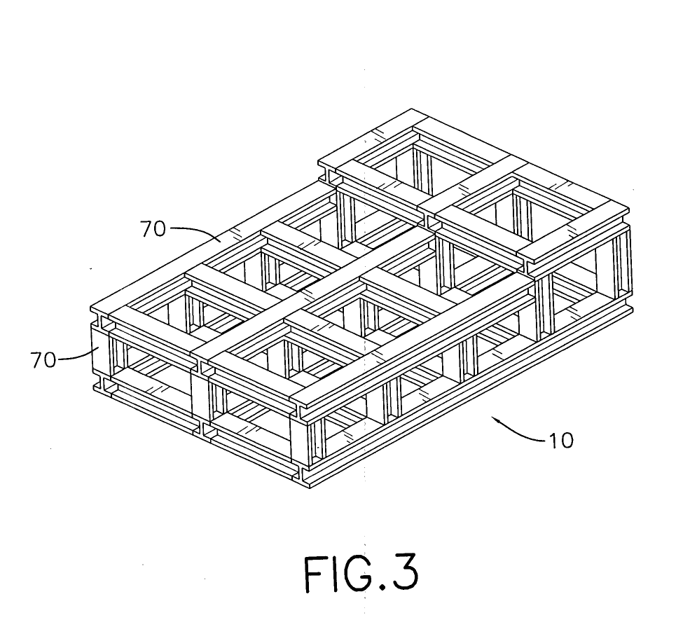

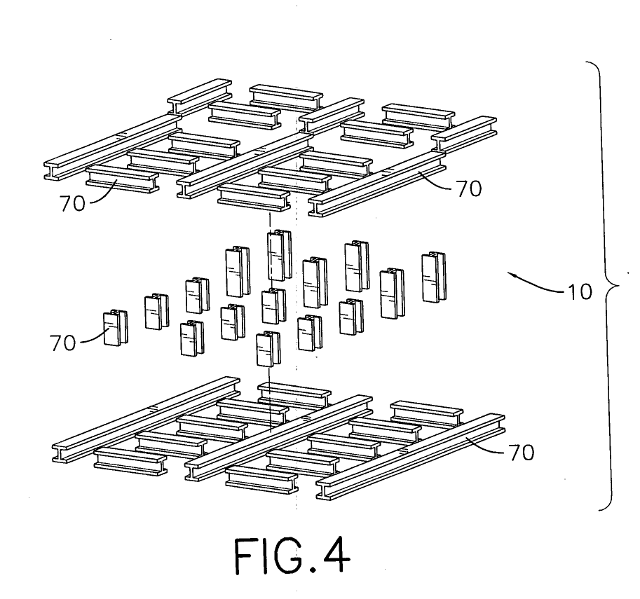

With reference to FIGS. 3 and 4, the base (10) is hollow, is the first structural assembly and has a top, two rails (11) and multiple slides (12). The rails (11) are mounted on the top of the base (10). The slides (12) are mounted slidably on the rails (11). The first structural assembly has multiple structural steel beams (70). Some of the structural steel beams (70) are arranged horizontally at intervals, and the other structural steel beams (70) are arranged vertically at intervals. All of the structural steel beams (70) are connected together to form the base (10).

The saddle (20) is hollow, is the second structural assembly, is mounted slidably on the slides (12) of the base (10), slides longitudinally relative to the base (10) and has a top, a bottom, two rails (21) and multiple slides (22). The rails (21) are mounted on the top of the saddle (20). The slides (22) are mounted slidably on the rails (21). The second structural assembly has multiple structural steel beams (70). Two of the structural steel beams (70) are separated by an interval, and the other structural steel beams (70) are mounted between the separate two structural steel beams (70) to form the saddle (20).

The table (30) is hollow, is the third structural assembly, is mounted slidably on the slides (22) of the saddle (20), slides transversely relative to the base (10) and has a bottom. The third structural assembly has multiple structural steel beams (70). The structural steel beams (70) are connected abreast to form the table (30).

The column (40) is hollow, is the fourth structural assembly, is mounted on the base (10) and has a front, two rails (41) and multiple slides (42). The rails (21) are mounted on the front of the column (40). The slides (42) are mounted slidably on the rails (41) of the column (40). The fourth structural assembly has multiple structural steel beams (70). Some of the structural steel beams (70) are arranged horizontally at intervals, other structural steel beams (70) are arranged vertically at intervals, and other structural steel beams (70) are arranged obliquely at intervals. The structural steel beams (70) are connected to other structural steel beams (70) to form the column (40).

The neck (50) is hollow, is the fifth structural assembly, is mounted slidably on the slides (42) of the column (40), slides vertically relative to the table (30) and has a rear end and a front end. The fifth structural assembly has multiple structural steel beams (70). Some of the structural steel beams (70) are arranged horizontally at intervals, other structural steel beams (70) are arranged vertically at intervals, and other structural steel beams (70) are arranged obliquely at intervals. The structural steel beams (70) are connected to other structural steel beams (70) to form the neck (50).

The head (51) is hollow and is attached to the front end of the neck (50).

The spindle (60) is mounted through the head (60) and has a blade.

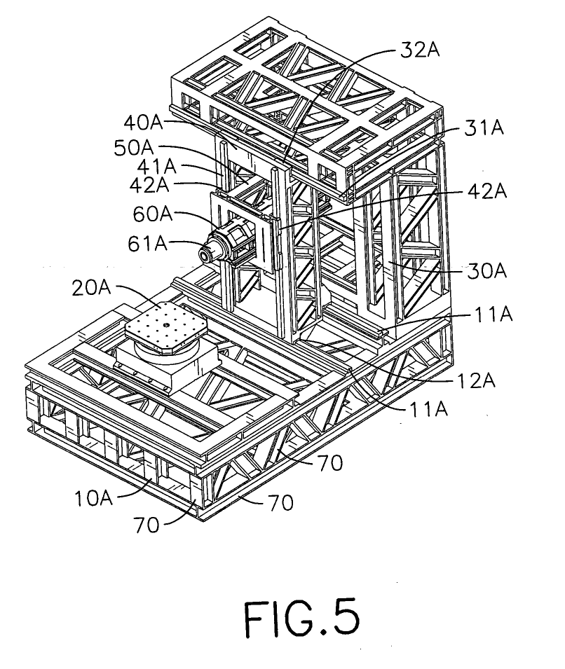

With reference to FIG. 5, a second embodiment of structural steel beam assemblies for a machining device in accordance with the present invention has a sixth, a seventh, an eighth and a ninth structural assembly. The structural steel beam assemblies are assembled to form a machining center. The machining center comprises a base (10A), a table (20A), a column (30A), a Y-axis saddle (40A), a Z-axis saddle (50A), a head (60A) and a spindle (61A). The base (10A), column (30A), Y-axis saddle (40A), Z-axis saddle (50A), head (60A) and spindle (61A) may be made individually of structural steel beams (70) such as channel iron, H-beams and I-beams.

The base (10A) is hollow, is the sixth structural assembly and has a top, two rails (11A) and multiple slides (12A). The rails (11A) are mounted on the top of the base (10A). The slides (22) are mounted slidably on the rails (11A) of the base (10A). The sixth structural assembly has multiple structural steel beams (70). Some of the structural steel beams (70) are arranged horizontally at intervals, other structural steel beams (70) are arranged vertically at intervals, and other structural steel beams (70) are arranged obliquely. The structural steel beams (70) are connected together to form the base (10A).

The table (20A) is mounted on the top of the base (10A).

The column (30A) is hollow, is mounted on the top of the base (10A), is the seventh structural assembly and has a top, a front, an overhang, a rail (31A) and multiple slides (32A). The overhang has a front and protrudes from the front of the column (30A) at the top. The rail (31A) is mounted on the overhang of the column (30A). The slides (32A) are mounted slidably on the rail (31A) on the column (30A). The seventh structural steel beam assembly has multiple structural steel beams (70). Some of the structural steel beams (70) are arranged horizontally at intervals, other structural steel beams (70) are arranged vertically at intervals, and other structural steel beams (70) are arranged obliquely. The structural steel beams (70) are connected to other structural steel beams (70) to form the column (30A).

The Y-axis saddle (40A) is hollow, is the eighth structural assembly, is mounted slidably on the slides (12A) on the base (10A) and the slides (32A) on the column (30A), slides transversely relative to the base (10A) and has a front, a vertical recess, two rails (41A) and multiple slides (42A). The vertical recess is formed in the front of the Y-axis saddle (40A). The rails (41A) are mounted on the front of the Y-axis saddle (40A). The slides (42A) are mounted slidably on the rails (41A) of the Y-axis saddle (40A). The eighth structural assembly has multiple structural steel beams (70). Some of the third structural steel beams (70) are arranged horizontally at intervals, other structural steel beams (70) are arranged vertically at intervals, and other structural steel beams (70) are arranged obliquely. The structural steel beams (70) are connected to other structural steel beams (70) to form the column (30A).

The Z-axis saddle (50A) is hollow, is the ninth structural assembly, is mounted in the vertical recess of the Y-axis saddle (40A) and slidably on the slides (42A) of the Y-axis saddle (40A), slides vertically relative to the base (10A) and has a front. The ninth structural assembly has multiple structural steel beams (70). Some of the structural steel beams (70) are arranged horizontally at intervals, other structural steel beams (70) are arranged vertically at intervals, and other structural steel beams (70) are arranged obliquely. The structural steel beams (70) are connected to other structural steel beams (70) to form the Z-axis saddle (50A).

The head (60A) is hollow, is mounted slidably through the front of the Z-axis saddle (50A), slides longitudinally relative to the base (10A) and has an open front.

The spindle (61A) is mounted in the open front of the head (60A) and has a blade.

The structural steel beams (70) in each structural assembly may be attached to other structural steel beams in the structural assembly by welding, bolts, rivets, clamps or the like.

A machining device made from structural steel beam assemblies has the following advantages.

1. The machining device is manufactured without wooden templates so a machining device designer can design a machine device without the restrictions inherent with wooden templates.

2. The machining device obviates the necessity for casting, tempering, machining and heat treatment. Therefore, time is saved in the manufacturing of the machining device.

3. Steel is stronger than iron in deformation resistance. Steel has a deformation resistance value about 161% of iron. Therefore, the machining device made of structural steel is light and compact.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A structural steel beam assembly for a machining device comprising:
multiple structural steel beams connected together to form a hollow structure and a component of the machining device.

2. The structural steel beam assembly as claimed in claim 1, wherein some of the structural steel beams are arranged horizontally at intervals, other structural steel beams are arranged vertically at intervals and the structural steel beams are connected together to form a hollow base of the machining device.

3. The structural steel beam assembly as claimed in claim 1, wherein two of the structural steel beams are separated by an interval, and the other structural steel beams are mounted between the separate two structural steel beams to form a hollow saddle of the machining device.

4. The structural steel beam assembly as claimed in claim 1, wherein the structural steel beams are connected abreast to form a hollow table of the machining device.

5. The structural steel beam assembly as claimed in claim 1, wherein:
some of the structural steel beams are arranged horizontally at intervals, other structural steel beams are arranged vertically at intervals, and other structural steel beams are arranged obliquely at intervals; and
the structural steel beams are connected together to form a hollow column of the machining device.

6. The structural steel beam assembly as claimed in claim 1, wherein:
some of the structural steel beams are arranged horizontally at intervals, other structural steel beams are arranged vertically at intervals, and other structural steel beams are arranged obliquely at intervals; and
the structural steel beams are connected together to form a hollow neck of the machining device.

7. The structural steel beam assembly as claimed in claim 1, wherein:
some of the structural steel beams are arranged horizontally at intervals, other structural steel beams are arranged vertically at intervals, and other structural steel beams are arranged obliquely; and
the structural steel beams are connected together to form a hollow base of the machining device.

8. The structural steel beam assembly as claimed in claim 1, wherein the structural steel beams are channel iron, H-beams and I-beams.

9. The structural steel beam assembly as claimed in claim 1, wherein the structural steel beams are connected together by welding.

10. A machining device with at least one structural steel beam assembly comprising:
a base having a top, two rails mounted on the top and multiple slides mounted slidably on the rails;
a saddle mounted slidably on the slides of the base, sliding longitudinally relative to the base and having a top, a bottom, two rails mounted on the top of the saddle, and multiple slides mounted slidably on the rails on the saddle;
a table mounted slidably on the slides of the saddle sliding transversely relative to the base and having a bottom;
a column mounted on the base and having a front, two rails mounted on the front of the column and multiple slides mounted slidably on the rails of the column;
a neck mounted slidably on the slides of the column, sliding vertically relative to the table and having a rear end and a front end;
a head attached to the front end of the neck; and
a spindle mounted through the head; wherein
at least one of the base, the saddle, the table, the column and the neck is a structural steel beam assembly having multiple structural steel beams, the structural steel beams are connected together to form a hollow structure.

11. A machining device with at least one structural steel beam assembly comprising:
a base having a top, two rails mounted on the top, and multiple slides mounted slidably on the rails;
a table mounted on the top of the base;
a column having a top, a front, an overhang having a front and protruding from the front of the column at the top, a rail mounted on the overhang of the column, and multiple slides mounted slidably on the rail on the column;
a Y-axis saddle mounted slidably on the slides on the base and the slides on the column, sliding transversely relative to the base and having a front, a vertical recess formed on the front of the Y-axis saddle, two rails mounted on the front of the Y-axis saddle, and multiple slides mounted slidably on the rails of the Y-axis saddle;
a Z-axis saddle mounted in the vertical recess of the Y-axis saddle and slidably on the slides of the Y-axis saddle, sliding vertically relative to the base and having a front;
a head mounted slidably through the front of the Z-axis saddle, sliding longitudinally relative to the base and has an open front; and
a spindle mounted in the open front of the head; wherein at least one of the base, the column, the Y-axis saddle, the Z-axis saddle is a structural steel beam assembly having multiple structural steel beams, the structural steel beams are connected together to form a hollow structure.
